(19) United States
(12) Patent Application Publication
(10) Pub. No.: US 2020/0229101 A1
(43) Pub. Date: Jul. 16, 2020

(54) Controlling Multi Connectivity

(71) Applicant: Nokia Solutions and Networks Oy, Espoo (FI)

(72) Inventors: Jeroen Wigard, Klarup (DK); Istvan Zsolt Kovacs, Aalborg (DK); Daniela Laselva, Klarup (DK); Claudio Rosa, Randers NV (DK)

(21) Appl. No.: 15/758,838

(22) PCT Filed: Sep. 28, 2015
(86) PCT No.: PCT/EP2015/072253

§ 371 Date: Mar. 9, 2018

(51) Int. Cl. H04W 52/14; H04W 76/16; H04W 72/04; H04W 72/12

(52) U.S. Cl. CPC H04W 52/146; H04W 72/1257; H04W 72/0473; H04W 76/16

(57) ABSTRACT

A solution for controlling multi connectivity is proposed. The solution comprises maintaining (200) a primary connection to a user terminal configured to operate using connectivity with plurality of connections wherein data packets are transmitted on the connections and receiving (202) indication of the power efficiency of at least one non-primary connection of the plurality of connections.

### TECHNICAL FIELD

The invention relates to communications.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

In recent years, the phenomenal growth of mobile Internet services and proliferation of smart phones and tablets has increased a demand for mobile broadband services, and hence more data transmission capacity is required. One possibility to increase a data transmission rate of a user apparatus is dual or multi connectivity. The basic principle of the dual connectivity is that the user apparatus may consume radio resources provided by at least two different network nodes. The network nodes may utilise different radio access technologies (RATs). One of the network nodes has a primary connection to the user apparatus and it is called a master network node which controls radio resources for the user apparatus.

### BRIEF DESCRIPTION

According to an aspect of the invention, there is provided an apparatus comprising: at least one processor; and at least one memory including computer program code, the at least one memory and the computer program code configured to, with the at least one processor, cause the apparatus at least to: maintain a primary connection to a user terminal configured to operate using connectivity with plurality of connections wherein data packets are transmitted on the connections; and receive indication of the power efficiency of at least one non-primary connection of the plurality of connections.

According to an aspect of the invention, there is provided method in an apparatus, comprising: maintaining a primary connection to a user terminal configured to operate using connectivity with plurality of connections wherein data packets are transmitted on the connections; and receiving indication of the power efficiency of at least one non-primary connection of the plurality of connections.

Some embodiments are defined in the dependent claims.

### LIST OF DRAWINGS

In the following the invention will be described in greater detail by means of preferred embodiments with reference to the attached [accompanying] drawings, in which

FIG. 1 illustrates a simplified example of a communication environment;

FIG. 2 is a flowchart illustrating an example embodiment of the invention;

FIGS. 3 and 4 illustrate simplified examples of apparatuses applying some embodiments of the invention.

### DETAILED DESCRIPTION OF SOME EMBODIMENTS

Embodiments are applicable to any base station, user terminal, user equipment, network element, server, corresponding component, and/or to any communication system or any combination of different communication systems that sup-port required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols and radio access technologies to be used in communications systems exist. Some examples of different communication systems are the universal mobile telecommunications system (UMTS) radio access network (UTRAN or E-UTRAN), long term evolution (LTE, known also as E-UTRA), long term evolution advanced (LTE-A), Wireless Local Area Network (WLAN) or WiFi based on IEEE 802.11 standard, worldwide interoperability for microwave ac-cess (WiMAX), Bluetooth®, personal communications services (PCS) and systems using ultra-wideband (UWB) technology. IEEE refers to the Institute of Electrical and Electronics Engineers.

Dual or multi connectivity, where a user apparatus may be connected simultaneously to radio resources provided by at least two different network nodes, has been the object of many studies recently. For example, 3GPP (Third Generation Partnership Project) has examined LTE-WiFi interworking. Other examples include LTE, LAA (Licensed Assisted Access) and LTE-U (LTE in Unlicensed spectrum). Similar concepts are expected for LTE-5G. In many of these concepts one of the participating RATs is a primary connection. The RAT having the primary connection is the controlling RAT, which is taking decisions related to e.g. the usage and configuration of the interworking mechanism, the data routing to other RATs. Typically the controlling RAT is LTE, but not necessarily.

In the uplink the limited resource in multi connectivity often is the transmission power of the user equipment (UE) or user terminal (UT). In the case of simultaneous uplink transmission it is so far not specified how this limited resource should be distributed over the different RATs. The user terminal transmit power is shared between the different RATs in a non-controllable way, as the different RATs typically run independent power settings. An obvious choice would be to split the power equally between the RATs the user terminal is connected to, but nothing stops the user terminal from using for instance 90% of its output power to one RAT (for instance WiFi) and only 10% to another RAT (for instance LTE).

In LTE based systems, the transmission power of a user terminal is set according to a power control formula where the user terminal gets some settings from the network. The specifications of LTE include the power settings in case of dual connectivity. In such a case where a user terminal is connected to two different LTE cells, there are two power control modes: one for synchronous and one for non-synchronous uplink transmissions. Main principle of both is that each of the links are guaranteed a configurable percentage of the maximum user transmit power. The percentages are configured from the primary cell.

In an embodiment of the invention, a power efficiency metric is utilised in transmission power control in multi connectivity situations. A power efficiency metric may be determined for a connection and the controlling RAT may then uses this metric in its scheduling/allocation decisions regarding the primary and other connections. In an embodiment, the user terminal measures or estimates the metric and reports it indirectly or directly to the controlling RAT.

In an embodiment, the purpose is to maximise the user terminal throughput. In order to maximize the throughput the output power should be used at the RAT where the highest throughput is achieved. There are several factors which have an effect on the throughput on a RAT per power unit.

First there is the Interference situation. The more there is interference, the higher power levels are required to reach the same SINR (signal-to-interference-plus-noise ratio) at the receiving node.

Second, the attenuation on the radio link between the user terminal and the receiving node. This depends on the distance and the frequency used.

Spectral efficiency including effects from overhead has an effect on the throughput as well. Different systems have different spectral efficiencies, depending also on different releases (such as different releases of LTE, for example). Control information overheads can also be different.

In addition, delays due to scheduling opportunities may be taken into account. For example, in a system such as WiFi a user terminal that has been transmitting cannot transmit to the system during a certain time interval after the transmission in order to give other UEs the opportunity to transmit. This has an impact on the overall throughput as well and thus on the overall power consumption. On the other hand with WiFi the channel access time in uplink can be much faster as compared to e.g. LTE since uplink data transmissions do not need to be scheduled by the access point.

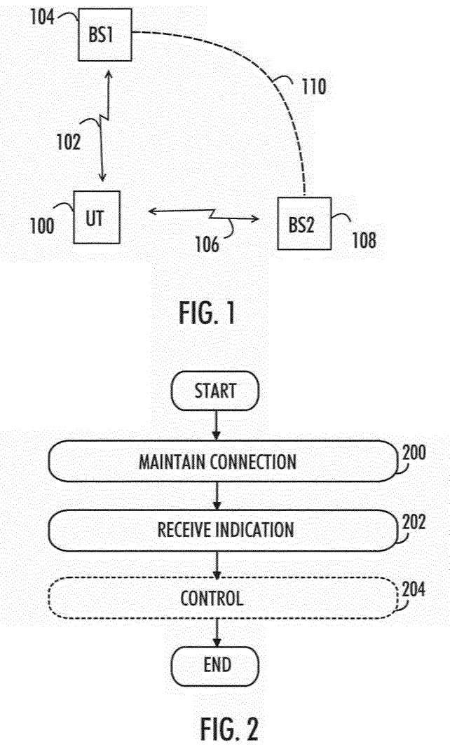

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

FIG. 1 further illustrates user terminal (UE) or user equipment (UT) 100 configured to communicate with one or more base station apparatuses of different RATs or different layers of a RAT. User terminal may refer to a portable computing device. Such computing devices include wireless mobile communication devices operating with or without a subscriber identification module (SIM), including, but not limited to, the following types of devices: mobile phone, smartphone, personal digital assistant (PDA), tablet computer, laptop computer. User terminal may be connected to a radio system via base stations for providing the user of the user terminal with access to the telecommunications system.

In the example of FIG. 1, the user terminal is in multi connectivity state as it is connected 102 to a first network node or a base station 104 and to 106 a second network node or a base station 108. The network nodes 104, 108 may be LTE eNodeBs, WiFi base stations or other base stations offering connections to the user terminal. The network nodes 104, 108 may be connected 110 either directly or indirectly via one or more communications systems. Here we may assume that the network node 104 is the controlling node of the multi connectivity of the user terminal. The network nodes 104, 108 may be of different RATs or they may be of different layers of a RAT. For example, the network node 104 may be a base station of an LTE based communication system and serving a macro cell and the network node 106 may be a base station of the same system serving a pico or macro cell which has a coverage area considerably smaller than the area of a macro cell.

FIG. 1 illustrates an example where the user terminal has two simultaneous connections. However, the number of connections is not limited to two as one skilled in the art is aware.

FIG. 2 is a flowchart illustrating an example embodiment of the operation of an apparatus. In the example of FIG. 2 the apparatus may be a network node of the controlling RAT. The apparatus may be an eNodeB, for example. The apparatus may also be another network element connected to the eNodeB.

In step 200, the apparatus 104 is configured to maintain a primary connection 102 to a user terminal 100 configured to operate using connectivity with plurality of connections wherein data packets are transmitted on the connections. In an embodiment, at least some of the plurality of connections utilise of different RATs or different layers of a RAT.

In step 202, the apparatus is configured to receive indication of the power efficiency of at least one non-primary connection 106 of the plurality of connections.

The apparatus may receive the indication of the power efficiency of at least one connection of the plurality of connections from the user terminal. For example, the user terminal 100 may measure the indication of the power efficiency of the connection 106 with the network node 108 and transmit the indication to the apparatus 104 on the connection 102.

In an embodiment, the apparatus may receive the indication of the power efficiency of at least one connection of the plurality of connections from a network element maintaining the connection. For example, the user terminal 100 may measure the indication of the power efficiency of the connection 106 with the network node 108 and transmit the indication to the network node 108 which may be configured to transmit the indication to the apparatus 100 on the connection 110.

In an embodiment, in step 204, the apparatus may be configured to control utilising the received indication the allocation and/or scheduling of data packets on the plurality of connections 102, 106.

In an embodiment, the apparatus may obtain indication on the power efficiency of the primary connection 102 with the user terminal and utilise the received indication the allocation and/or scheduling of data packets on the plurality of connections 102, 106. For example, the user terminal 100 may measure the indication of the power efficiency of the connection 102 with the apparatus and transmit the indication to the apparatus 104 on the connection 102.

In an embodiment, the apparatus 100 may be configured to control the properties of the multi connectivity connections of the user terminal to maximise the overall throughput and power efficiency of the user terminal.

The apparatus may be configured to use a power efficiency metric to control or configure how a RAT or a layer of the apparatus is coordinating its own uplink allocations and the uplink data scheduling of the other RATs or layers for a user terminal configured in multi-connectivity in the uplink.

The apparatus may thus be configured to receive at least one power efficiency metric for at least one non-controlling RAT or layer. Possible metrics may be the measurement of the power efficiency (estimated over a certain period of time), or the used output power corresponding to a measured or estimated throughput, for example. The measurements made by the user terminal may be absolute power, quantified power, relative power, or the power efficiency over a certain time period, for example.

The apparatus may be further configured to use the power efficiency metric to adjust the allocations and/or scheduling of the data packets across the RATs or layers in order to optimise the overall uplink throughput and power efficiency of the user terminal. The indications or measurements originating from different RATs or layers may be adjusted to obtain comparable results. For example, some mapping for the received indications may be performed in order to compare them.

The apparatus 100 may control the properties of the multi connectivity connections of the user terminal is various ways. For example, in a situation where LTE is the controlling RAT, it has the means of controlling/impacting the uplink transmissions across the different RATs. For example, by adjusting the LTE uplink grant the LTE RAT does impact the cross RAT scheduling. For instance the LTE grant may be set to 0, in which case all traffic goes through other connections such as WiFi. At the same time it can impact the power used by changing the power control settings for the user equipment. The WiFi power efficiency metric, which can be a power spectral efficiency measure or a direct power measure, for example, can be exchanged directly by the user terminal over the air to the controlling (LTE) RAT or layer or indirectly through its own non-controlling RAT or layer, where the measurement then is forwarded through the connection 110 on the network side between the two RATs.

The same mechanism can be applied for multi connectivity between LTE and 5G or LTE and LTE-U, for example. The only difference is that in these latter cases the allocations and or scheduling of the data packets across the RATs is less difficult to achieve compared to the LTE and WiFi case.

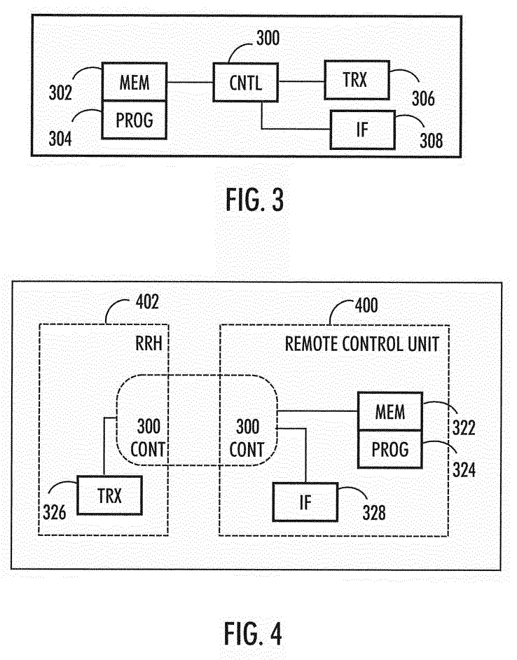

FIG. 3 illustrates an embodiment. The figure illustrates a simplified example of an apparatus applying embodiments of the invention. In some embodiments, the apparatus may be an eNodeB or a base station or a part of an eNodeB or a base station of a communications system. In some embodiments, the apparatus may be a WiFi base station or a part of a WiFi base station.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 300 configured to control at least part of the operation of the apparatus.

The apparatus may comprise a memory 302 for storing data. Furthermore the memory may store software 304 executable by the control circuitry 400. The memory may be integrated in the control circuitry.

The apparatus comprises a transceiver 306. The transceiver is operationally connected to the control circuitry 300. It may be connected to an antenna arrangement (not shown).

The software 304 may comprise a computer program comprising program code means adapted to cause the control circuitry 300 of the apparatus at least to maintain a primary connection to a user terminal configured to operate using connectivity with plurality of connections wherein data packets are transmitted on the connections, receive indication of the power efficiency of at least one connection of the plurality of connections; and control utilising the received indication the allocation and/or scheduling of data packets on the plurality of connections.

The apparatus may further comprise interface circuitry 308 configured to connect the apparatus to other devices and network elements of communication system, for example to core. The interface may provide a wired or wireless connection to the communication network. The apparatus may be in connection with core network elements, other eNodeB's, Home NodeB's, with other respective apparatuses of communication systems and other communication systems.

In an embodiment, as shown in FIG. 4, at least some of the functionalities of the apparatus of FIG. 3 may be shared between two physically separate devices, forming one operational entity. Therefore, the apparatus may be seen to depict the operational entity comprising one or more physically separate devices for executing at least some of the described processes. Thus, the apparatus of FIG. 4, utilizing such shared architecture, may comprise a remote control unit RCU 400, such as a host computer or a server computer, operatively coupled (e.g. via a wireless or wired network) to a remote radio head RRH 402 located in the base station. In an embodiment, at least some of the described processes may be performed by the RCU 400. In an embodiment, the execution of at least some of the described processes may be shared among the RRH 402 and the RCU 400.

In an embodiment, the RCU 400 may generate a virtual network through which the RCU 400 communicates with the RRH 402. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (e.g. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

The embodiments are not, however, restricted to the systems given above as an example but a person skilled in the art may apply the solution to other communication systems provided with necessary properties. Another example of a suitable communications system is the 5G concept. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates. 5G will likely be comprised of more than one radio access technology, each optimized for certain use cases and/or spectrum. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz—cmWave, below 6 GHz—cmWave—mmWave). One of the concepts considered to be used in 5G networks is network slicing in which multiple independent and dedicated virtual sub-networks (network instances) may be created within the same infrastructure to run services that have different requirements on latency, reliability, throughput and mobility.

It will be obvious to a person skilled in the art that, as the technology advances, the inventive concept can be implemented in various ways. The invention and its embodiments are not limited to the examples described above but may vary within the scope of the claims.

1. An apparatus comprising:
at least one processor; and
at least one non-transitory memory including computer program code,
the at least one non-transitory memory and the computer program code configured to, with the at least one processor, cause the apparatus at least to:
maintain a primary connection of the apparatus to a user terminal, where the user terminal is configured to operate using connectivity with a plurality of connections, wherein data packets are transmitted on the plurality of connections; and
receive indication of an uplink power efficiency of at least one non-primary connection of the plurality of connections.

2. The apparatus of claim 1, wherein at least some of the plurality of connections utilise different radio access technologies.

3. The apparatus of claim 1, where the at least one non-transitory memory and the computer program code are configured to, with the at least one processor, cause the apparatus further to:
determine an uplink power efficiency of the primary connection; and
control, utilising the determined uplink power efficiency of the primary connection and the received indication, allocation and/or scheduling of the data packets on the plurality of connections.

4. The apparatus of claim 3, wherein the control of the allocation and/or scheduling comprises optimising overall throughput and power efficiency of the user terminal.

5. The apparatus of claim 1, wherein the indication is based on at least one of:
a measured power efficiency of the at least one non-primary connection of the plurality of connections, and
an output power used by the user terminal corresponding to measured or estimated throughput.

6. (canceled)

7. The apparatus of claim 1, where the at least one non-transitory memory and the computer program code are configured to, with the at least one processor, cause the apparatus further to:
receive the indication of the uplink power efficiency of the at least one non-primary connection of the plurality of connections from a network element maintaining the non-primary connection.

8. The apparatus of claim 1, where the at least one non-transitory memory and the computer program code are configured to, with the at least one processor, cause the apparatus further to:
receive the indication of the uplink power efficiency of the at least one non-primary connection of the plurality of connections from the user terminal.

9. The apparatus of claim 1, wherein the indication is at least one of: absolute power, quantified power, relative power or power efficiency over a given period of the at least one non-primary connection of the plurality of connections.

10. (canceled)

11. (canceled)

12. A method comprising:
maintaining a primary connection to a user terminal, where the user terminal is configured to operate using connectivity with a plurality of connections, wherein data packets are transmitted on the plurality of connections; and
receiving indication of an uplink power efficiency of at least one non-primary connection of the plurality of connections.

13. The method of claim 12, wherein at least some of the plurality of connections utilise different radio access technologies.

14. The method of claim 12, further comprising:
determining an uplink power efficiency of the primary connection and control, utilising the determined power efficiency of the primary connection and the received indication, allocation and/or scheduling of the data packets on the plurality of connections.

15. The method of claim 14, wherein the control of the allocation and/or scheduling comprises optimising overall throughput and power efficiency of the user terminal.

16. The method of claim 12, wherein the indication is based on a measured power efficiency of the at least one non-primary connection of the plurality of connections.

17. The method of claim 12, wherein the indication is based on an output power used by the user terminal corresponding to a measured or estimated throughput.

18. The method of claim 12, further comprising:
receiving the indication of the uplink power efficiency of the at least one non-primary connection of the plurality of connections from a network element maintaining the non-primary connection.

19. The method of claim 12, further comprising:
receiving the indication of the uplink power efficiency of the at least one non-primary connection of the plurality of connections from the user terminal.

20. The method of claim 12, wherein the indication is at least one of: absolute power, quantified power, relative power or power efficiency over a given period of the at least one non-primary connection of the plurality of connections.

21. The method of claim 12, wherein the primary connection is a cellular connection and the at least one non-primary connection of the plurality of connections is a wireless local area connection.

22. The method of claim 12, wherein the primary connection and the at least one non-primary connection of the plurality of connections are cellular connections.

23. (canceled)

24. A non-transitory program storage device readable by a machine, tangibly embodying a program of instructions executable by the machine for performing operations, the operations comprising:
maintaining a primary connection to a user terminal, where the user terminal is configured to operate using connectivity with a plurality of connections, wherein data packets are transmitted on the plurality of connections; and
receiving indication of an uplink power efficiency of at least one non-primary connection of the plurality of connections.
